(19) United States
(12) Patent Application Publication
(10) Pub. No.: US 2022/0258569 A1
(43) Pub. Date: Aug. 18, 2022

(54) METHOD FOR MANAGING A THERMAL MANAGEMENT DEVICE FOR A MOTOR VEHICLE

(71) Applicant: Valeo Systemes Thermiques, Le Mesnil Saint-Denis (FR)

(72) Inventors: Jugurtha Benouali, Le Mesnil Saint-Denis (FR); Régis Beauvis, Le Mesnil Saint-Denis (FR); Jin-Ming Liu, Le Mesnil Saint-Denis (FR)

(73) Assignee: Valeo Systemes Thermiques, Le Mesnil Saint-Denis (FR)

(21) Appl. No.: 17/623,016

(22) PCT Filed: Jun. 22, 2020
(86) PCT No.: PCT/FR2020/051081

§ 371 Date: Dec. 27, 2021

(30) Foreign Application Priority Data
Jun. 28, 2019 (FR) FR1907104

(51) Int. Cl. B60H 1/00

(52) U.S. Cl. CPC B60H 1/00921; B60H 1/00278; B60H 2001/00942; B60H 2001/00928; B60H 2001/00307

(57) ABSTRACT

A method for managing a thermal management device for a motor vehicle is disclosed. The device has a refrigerant circuit that circulates a refrigerant fluid. The circuit includes a main loop having, in the direction of circulation of the fluid, a compressor, a condenser configured to exchange heat energy with a first element, a first expansion device and a first evaporator configured to exchange heat energy with a second element. The device operates in a mode of strict cooling of the third element in which the condenser transfers heat energy to the first element and only the second evaporator absorbs heat energy from the third element. The method includes managing the open diameter of the first expansion device as a function of the ambient temperature so that the refrigerant fluid circulates inside the first evaporator, the open diameter of the first expansion device decreasing as the ambient temperature of the first element increases.

The present invention relates to a method for managing a thermal management device for a motor vehicle and to the thermal management device for implementing such a method.

More specifically, the invention relates to a management method for a thermal management device comprising a refrigerant circuit comprising two evaporators arranged parallel to each other and each comprising a dedicated refrigerant fluid expansion device that is arranged upstream.

As a general rule, the two evaporators are dedicated to cooling separate elements such as, for example, an internal air flow intended for the passenger compartment of the motor vehicle for a first evaporator and electronic and/or electrical elements such as batteries for a second evaporator. However, it may happen that, when only the second evaporator is being used, to cool electronic and/or electrical elements such as batteries, the pressure inside the first evaporator rises, possibly damaging said first evaporator. Moreover, owing to overheating of the refrigerant fluid at the outlet of the second evaporator, it may also happen that the refrigerant fluid reaches a temperature that is too high at the compressor outlet, potentially damaging said compressor.

One of the aims of the present invention is therefore to at least partially remedy the drawbacks of the prior art and to propose a method for managing an improved thermal management device in order to protect the first evaporator and the compressor when only the thermal management device of the second evaporator is being used, to cool electronic and/or electrical elements such as batteries.

Therefore, the present invention relates to a method for managing a thermal management device for a motor vehicle comprising a refrigerant circuit, in which a refrigerant fluid is intended to circulate, said refrigerant circuit comprising:
a main loop comprising, in the direction of circulation of the refrigerant fluid, a compressor, a condenser configured to exchange heat energy with a first element, a first expansion device and a first evaporator configured to exchange heat energy with a second element;
a bypass branch arranged parallel to the first expansion device and the first evaporator, said bypass branch comprising a second expansion device and a second evaporator arranged downstream of the second expansion device and configured to exchange heat energy with a third element,
   said thermal management device operating in a mode of strict cooling of the third element in which the condenser transfers heat energy to the first element and only the second evaporator absorbs heat energy from the third element,
   said management method comprising a step of managing the open diameter of the first expansion device as a function of the ambient temperature so that the refrigerant fluid circulates inside the first evaporator, the open diameter of the first expansion device decreasing as the ambient temperature of the first element increases.

According to one aspect of the method according to the invention:
if the ambient temperature is above 25° C., the open diameter of the first expansion device is of the order of 5% of its maximum open diameter,
if the ambient temperature is less than or equal to 25° C., the open diameter of the first expansion device is of the order of 20% of its maximum open diameter.

According to another aspect of the invention, the management method comprises a step of managing the speed of rotation of the compressor such that the temperature of the third element after heat exchange with the second evaporator reaches and maintains a setpoint value.

According to another aspect of the invention, the management method comprises a step of managing the open diameter of the second expansion device as a function of the difference between the overheating of the refrigerant fluid at the owlet of the second evaporator and an overheating setpoint.

According to another aspect of the invention, the management method comprises:
a step of determining the maximum admissible overheating of the refrigerant fluid at the inlet of the compressor for a maximum setpoint temperature of the refrigerant fluid at the outlet of the compressor,
a step of determining the overheating of the refrigerant fluid at the inlet of the compressor,
a step of comparing the overheating of the refrigerant fluid at the inlet of the compressor with the maximum admissible overheating of the refrigerant fluid at the inlet of the compressor determined,
   if the overheating of the refrigerant fluid at the inlet of the compressor is greater than the maximum admissible overheating of the refrigerant fluid at the inlet of the compressor, the management method includes a step of lowering the overheating of the refrigerant fluid at the inlet of the compressor until the overheating of the refrigerant fluid at the inlet of the compressor is less than or equal to the maximum admissible overheating of the refrigerant fluid at the inlet of the compressor.

According to another aspect of the method according to the invention, the second expansion device is an electronic expansion valve and the step of lowering the overheating of the refrigerant fluid at the inlet of the compressor is carried out by opening said second expansion device.

According to another aspect of the method according to the invention, the step of lowering the overheating of the refrigerant fluid at the inlet of the compressor is carried out by opening the first expansion device such that the refrigerant fluid passes through the first evaporator.

According to another aspect of the method according to the invention, the step of lowering the overheating of the refrigerant fluid at the inlet of the compressor is also carried out by reducing the speed of rotation of the compressor.

According to another aspect of the method according to the invention:
the condenser is a heat exchanger arranged jointly on the main loop and on a secondary loop inside which a heat transfer fluid is intended to circulate and the first element is said heat transfer fluid,
the first evaporator is a heat exchanger arranged within a heating, ventilation and air-conditioning device and the second element is an internal air flow intended for the passenger compartment,
the second evaporator is configured to cool electrical and/or electronic elements such as batteries.

According to another aspect of the method according to the invention, the secondary loop comprises:
the first heat exchanger,
a first heat transfer fluid circulation pipe comprising a fifth internal exchanger intended to have the internal air flow passing through it, the first circulation pipe connecting a first connection point arranged downstream of the first heat exchanger and a second connection point arranged upstream of said first heat exchanger,
a second circulation pipe for the first heat transfer fluid comprising a sixth internal exchanger intended to have an external air flow passing through it, the second circulation pipe also connecting the first connection point arranged downstream of the first heat exchanger and the second connection point arranged upstream of said first heat exchanger, and
a pump arranged downstream or upstream of the first heat exchanger, between the first connection point and the second connection point.

Further features and advantages of the present invention will become more clearly apparent upon reading the following description, which is provided by way of a non-limiting illustration, and with reference to the accompanying drawings, in which:

FIG. 1 is a schematic depiction of a thermal management device according to a first embodiment;

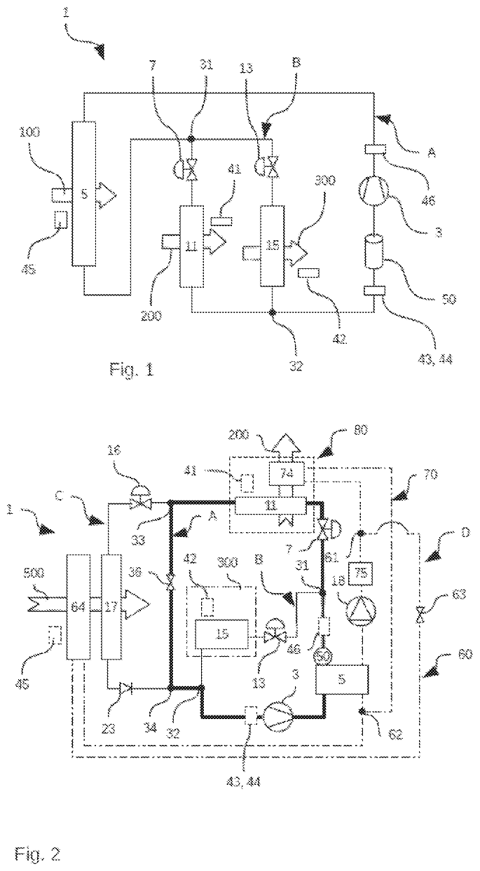

FIG. 2 is a schematic depiction of a thermal management device according to a second embodiment;

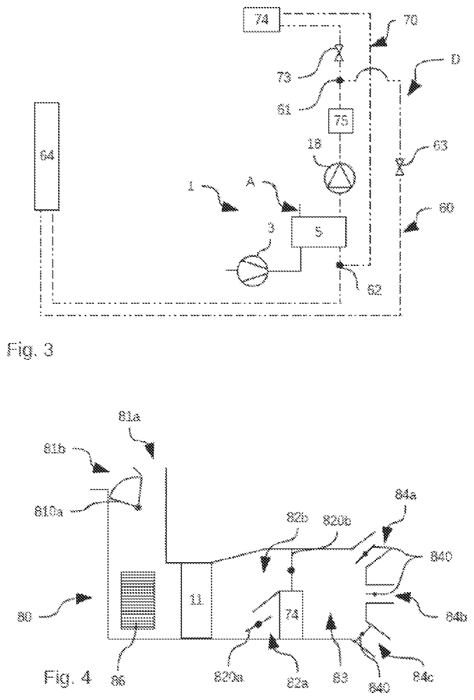

FIG. 3 is a schematic depiction of the secondary loop according to an alternative embodiment;

FIG. 4 is a schematic depiction of a heating, ventilation and/or air-conditioning device;

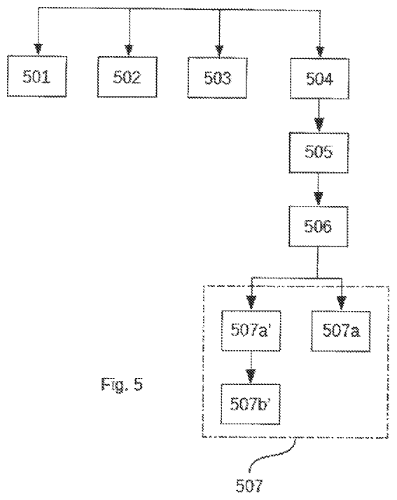

FIG. 5 shows a flow diagram illustrating the steps in the thermal management method.

In the various figures, identical elements bear the same reference numbers.

The following embodiments are examples. Although the description refers to one or more embodiments, this does not necessarily mean that each reference relates to the same embodiment, or that the features only apply to a single embodiment. Simple features of various embodiments may also be combined and/or interchanged in order to provide other embodiments.

In the present description, some elements or parameters may be indexed, such as, for example, a first element or a second element, as well as a first parameter and a second parameter or even a first criterion and a second criterion, etc. In this case, it is a case of simple indexing for differentiating and denominating elements or parameters or criteria that are similar but not identical. This indexing does not imply the priority of one element, parameter or criterion over another and such denominations may be easily interchanged without departing from the scope of the present description. This indexing also does not imply an order in time, for example, for assessing such or such a criterion.

In the present description, “placed upstream” is understood to mean that one element is placed before another in relation to the direction of circulation of a fluid. By contrast, “placed downstream” is understood to mean that one element is placed after another in relation to the direction of circulation of the fluid.

FIG. 1 is a schematic depiction of a thermal management device 1 for a motor vehicle according to a simple embodiment. The thermal management device 1 comprises a refrigerant circuit, in which a refrigerant fluid is intended to circulate. This refrigerant circuit comprises a main loop A comprising, in the direction of circulation of the refrigerant fluid, a compressor 3, a condenser 5 configured to exchange heat energy with a first element 100, a first expansion device 7 and a first evaporator 11. This first evaporator 11 is more particularly configured to exchange heat energy with a second element 200.

The main loop A can also comprise a phase separation device 50 arranged upstream of the compressor 3.

The refrigerant circuit also comprises a bypass branch B arranged parallel to the first expansion device 7 and the first evaporator 11. This bypass branch B comprises a second expansion device 13 and a second evaporator 15 arranged downstream of the second expansion device 13. The second evaporator 15 is more particularly configured to exchange heat energy with a third element 300.

More specifically, the bypass branch B connects a first 31 and a second 32 connection point to the main loop A. The first connection point 31 is arranged upstream of the first expansion device 7, between the condenser 5 and said first expansion device 7. The second connection point 32 for its part is arranged downstream of the first evaporator 11, between said first evaporator 11 and the compressor 3.

A condenser 5, a first 11 and second 15 evaporator are herein understood to mean a heat exchanger defined by its function. A condenser will then have the function of heating the element with which it exchanges heat energy and an evaporator will have the function of cooling the element with which it exchanges heat energy.

As shown in FIG. 1, the first 100, second 200 and third 300 elements respectively exchanging with the condenser 5 and the first 11 and second 15 evaporators, can be air flows passing through said heat exchangers. However, according to the type of heat exchanger, then clearly there is nothing preventing the first 100, second 200 and third 300 elements from being other types, such as, for example, a heat transfer fluid or an element in direct contact with the evaporator such as batteries, for example. The condenser 5 and the first 11 and second 15 evaporators thus can be, for example, air heat exchangers when the first 100, second 200 and third 300 elements are air flows, can be plate type heat exchangers when they are in direct contact with the first 100, second 200, and third 300 elements or even can be dual-fluid heat exchangers when the first 100, second 200 and third 300 elements are heat transfer fluids circulating in an auxiliary thermal management circuit.

FIG. 2 for its part shows an example of a more complex thermal control device 1. In this example, the thermal management device 1 is reversible, i.e. it can equally cool and heat an internal air flow 200 intended for the passenger compartment.

The thermal management device 1 of FIG. 2 thus also comprises a refrigerant circuit, in which a refrigerant fluid is intended to circulate. This refrigerant circuit comprises a main loop A and a secondary loop D in which a heat transfer fluid is intended to circulate.

The main loop A includes, in the direction of circulation of the refrigerant fluid, a compressor 3, a first heat exchanger 5, a first expansion device 7 and a second heat exchanger 11.

The main loop A also comprises a bypass branch B arranged parallel to the first expansion device 7 and the first evaporator 11. This bypass branch B comprises a second expansion device 13 and a third heat exchanger 15 arranged downstream of the second expansion device 13.

More specifically, the bypass branch B connects a first 31 and a second 32 connection point to the main loop A. The first connection point 31 is arranged upstream of the first expansion device 7, between the first heat exchanger 5 and said first expansion device 7. The second connection point 32 for its part is arranged downstream of second heat exchanger 11, between said second heat exchanger 11 and the compressor 3.

The first heat exchanger 5 is in this case a condenser arranged jointly on the main loop A and on the secondary loop D in order to allow exchanges of heat energy between the refrigerant fluid of the main loop A and the heat transfer fluid of the secondary loop D, which thus acts as first element 100.

The second heat exchanger 11 is in this case a first evaporator, for example arranged within a heating, ventilation and/or air-conditioning (or HVAC) device 80. This second heat exchanger 11 is intended to exchange, in this case, with an internal air flow intended for the passenger compartment, which acts as the second element 200.

The third heat exchanger 15 for its part is a second evaporator configured to exchange heat energy and more particularly to cool, by direct contact, electronic and/or electrical elements such as batteries.

The main loop A may also include a diversion branch C. This diversion branch C may more specifically connect a third connection point 33 and a fourth connection point 34 arranged on said main loop A.

The third connection point 31 is preferably arranged, in the direction of circulation of the refrigerant fluid, downstream of the second heat exchanger 11, between said second heat exchanger 11 and the compressor 3. More particularly, and as shown in FIG. 2, the third connection point 33 is arranged between the second heat exchanger 11 and the second connection point 32 of the bypass branch B. The fourth connection point 34 for its part is preferably arranged downstream of the third connection point 33, between said third connection point 33 and the compressor 3, preferably upstream of the second connection point 32 of the bypass branch B.

This diversion branch C has a third expansion device 16 arranged upstream of a fourth heat exchanger 17. This fourth heat exchanger 17 may for example be a third evaporator arranged on the front end of the motor vehicle in order to exchange heat energy with an external air flow 500.

The diversion branch C may also comprise a nonreturn valve 23 arranged downstream of the fourth heat exchanger 17 in order to prevent any reflux of refrigerant fluid coming from the fourth connection point 34 towards the fourth heat exchanger 17.

In order to control whether or not the refrigerant fluid passes into the diversion branch C, the main branch includes a device for redirecting the refrigerant fluid coming from the second heat exchanger 11 to said diversion branch C or directly to the compressor 3. This refrigerant fluid redirection device may in particular include a shut-off valve 36 arranged on the main branch A between the third 33 and the fourth 34 connection point. This shut-off valve 36 may be an all-or-nothing valve or indeed a proportional valve of which the degree of opening is controlled. So that the refrigerant fluid does not pass through the fourth heat exchanger 17, the third expansion device 16 may notably comprise a shut-off function, in other words it may be configured to block the flow of refrigerant fluid when closed. An alternative may be to position a shut-off valve between the third expansion device 16 and the third connection point 33.

Another alternative (not depicted) may also be to fit a three-way valve at the third connection point 33.

What is meant here by a shut-off valve, a nonreturn valve, a three-way valve or an expansion device with shut-off function, are mechanical or electromechanical elements which can be operated by an electronic control unit carried on board the motor vehicle.

The main loop A may also include, in addition to a phase separation device, a bottle of desiccant 50 arranged downstream of the first heat exchanger 5, more specifically between said first heat exchanger 5 and the first expansion device 7. Such a bottle of desiccant 50 placed on the high-pressure side of the air-conditioning circuit, namely downstream of the compressor 3 and upstream of an expansion device, represents less bulk and a lower cost by comparison with other phase separation solutions such as an accumulator which would be positioned on the low-pressure side of the air-conditioning circuit, namely upstream of the compressor 3.

The first expansion device 7 may, for example, be an electronic expansion valve, namely an expansion valve the outlet refrigerant fluid pressure of which is controlled by an actuator which fixes the open cross section of the expansion device, thus fixing the outlet pressure of the fluid. Such an electronic expansion valve is notably configured to allow the refrigerant fluid to pass without a drop in pressure when said expansion device is fully open.

Like the third expansion device 16, the second expansion device 13 may include a shut-off function in order to allow the refrigerant fluid to pass through the bypass branch B or prevent it from doing so. An alternative is to have a shut-off valve on the bypass branch B, upstream of the second expansion device 13. This second expansion device 13 may be an electronic expansion valve controlled by the central control unit 90 or may be a thermostatic expansion valve or an orifice tube.

The third expansion device 16 also be an electronic expansion valve.

The secondary loop 1) may for its part include the first heat exchanger 5 and a first circulation pipe 70 for the heat transfer fluid comprising a fifth internal exchanger 74, also referred to as an internal radiator and intended to have the internal air flow 200 passing through it. This fifth heat exchanger 74 is in particular arranged in the heating, ventilation and/or air-conditioning device 80. More specifically, the fifth heat exchanger 74 is arranged downstream of the second heat exchanger 11 in the direction of circulation of the internal air flow 200. This first circulation pipe 70 connects a first connection point 61 arranged downstream of the first heat exchanger 5 and a second connection point 62 arranged upstream of said first heat exchanger 5.

The secondary loop D may also include a second circulation pipe 60 for the first heat transfer fluid comprising a sixth heat exchanger 64, also referred to as an external radiator and intended to have an external air flow 500 passing through it, for example on the front end of the motor vehicle. The sixth heat exchanger 64 is notably arranged upstream of the third heat exchanger 17 in the direction of circulation of the external air flow 500. This second circulation pipe 60 also connects the first connection point 61 arranged downstream of the first heat exchanger 5 and the second connection point 62 arranged upstream of said first heat exchanger 5.

The secondary loop D further comprises a pump 18 arranged downstream or upstream of the first heat exchanger 5, between the first connection point 61 and the second connection point 62.

The secondary loop D may also comprise a device for redirecting the heat transfer fluid coming from the first heat exchanger 5 to the first circulation pipe 70 and/or to the second circulation pipe 60.

As shown in FIG. 2, said device for redirecting the heat transfer fluid coming from the first heat exchanger 5 may notably comprise a shut-off valve 63 positioned on the second circulation pipe 60 so as to block or not block the heat transfer fluid and thus prevent it from circulating in said second circulation pipe 60.

This embodiment notably makes it possible to limit the number of valves in the secondary loop D, thus making it possible to limit production costs.

According to an alternative embodiment shown in FIG. 3, depicting the secondary loop D, the device for redirecting the heat transfer fluid coming from the first heat exchanger 5 may notably comprise:
a shut-off valve 63 positioned on the second circulation pipe 60 so as to block or not block the first heat transfer fluid and prevent it from circulating in said second circulation pipe 60, and
another shut-off valve 73 positioned on the first circulation pipe 70 so as to block or not block the heat transfer fluid and prevent it from circulating in said first circulation pipe 70.

The secondary loop D may also comprise an electric heating element 75 for heating the heat transfer fluid. Said electric heating element 75 is notably positioned, in the direction of circulation of the heat transfer fluid, downstream of the first heat exchanger 5, between said first heat exchanger 5 and the first connection point 61.

As described above, the fifth 74 and the second 11 heat exchanger are arranged within a heating, ventilation and/or air-conditioning device 80. As shown in FIG. 4, the heating, ventilation and/or air-conditioning device 80 may include a supply line 81a for supplying outside air and a supply line 81b for supplying recirculated air (i.e. air coming from passenger compartment). These two supply tines 81a and 81b both bring air to the second heat exchanger 11 so that it passes through the latter. In order to choose where the air passing through the second heat exchanger 11 comes from, the heating, ventilation and/or air-conditioning device 80 comprises a shutter 810a, for example a drum-type shutter, configured to completely or partially close off the outside air supply line 81a or the recirculated air supply line 81b.

Inside, the heating, ventilation and/or air-conditioning device 80 comprises a heating pipe 82a for bringing air that has passed through the second heat exchanger 11 to the fifth heat exchanger 74 so that it passes through the latter and is heated before arriving at a distribution chamber 83. This heating pipe 82a also includes a shutter 820a configured to close it off completely or partially.

The heating, ventilation and/or air-conditioning device 80 may also include a diversion line 82b from the fifth heat exchanger 74. This diversion line 82b allows the air that has passed through the second heat exchanger 11 to go directly into the distribution chamber 83, without passing through the fifth heat exchanger 74. This diversion line 82b also includes a shutter 820b configured to close it off completely or partially.

In the distribution chamber 83, the air may be sent to the windshield via an upper duct 84a, to the dashboard of the passenger compartment via a center duct 84b and/or to the bottom of the dashboard of the passenger compartment via a lower duct 84c. Each of these ducts 84a, 84b, 84c comprises a shutter 840 configured to close them off completely or partially.

The heating, ventilation and/or air-conditioning device 80 also includes a blower 86 for blowing the internal air flow 200. This blower 86 may be arranged upstream of the second heat exchanger 11 in the direction of circulation of the internal air flow 200.

As shown in FIGS. 1 and 2, the thermal management device 1 may also include various sensors for measuring and determining certain parameters.

The thermal management device 1 may thus include a first temperature sensor 41 configured to measure the temperature of the second element 200 after it has exchanged heat energy with the first evaporator 11. It may thus be, for example, a temperature sensor 41 arranged downstream of the first evaporator 11 in the direction of circulation of an internal air flow 200.

The thermal management device 1 may include a second temperature sensor 42 configured to measure the temperature of the third element 300 after it has exchanged heat energy with the second evaporator 15. It may thus be, for example, a temperature sensor 42 measuring the temperature of electronic and/or electrical elements such as batteries.

The thermal management device 1 may include a third temperature sensor 43 configured to measure the temperature of the refrigerant fluid before it enters the compressor 3 and a fourth pressure sensor 44 for measuring the pressure of the refrigerant fluid before it enters the compressor 3. These two sensors 43 and 44 may in particular be combined within a single device arranged upstream of the compressor 3, between the second connection point 32 and said compressor 3.

The thermal management device 1 may also comprise a fifth ambient temperature sensor 45. In this case, ambient temperature means the temperature outside the motor vehicle. This fifth sensor 45 may thus be arranged outside the motor vehicle, for example upstream of the sixth heat exchanger 64 in the direction of circulation of the external air flow 100 or 500.

Lastly, the thermal management device 1 may include a sixth sensor 46 for detecting the pressure of the refrigerant fluid at the outlet of the compressor 3. This sixth pressure sensor 46 may be arranged downstream of the compressor 3, as shown in FIG. 1, or may be arranged downstream of the first heat exchanger 5, as shown in FIG. 2.

FIG. 5 shows a diagram illustrating the various steps in the management method according to the invention.

When the thermal management device 1 operates in a mode of strict cooling of the third element 300 in which the condenser 5 transfers heat energy to the first element 100 and only the second evaporator 15 absorbs heat energy from the third element 300, the management method comprises a first step 501 of managing the open diameter of the first expansion device 7.

In this first step 501, the open diameter of the first expansion device 7 is set as a function of the ambient temperature such that the refrigerant fluid circulates through the first evaporator 11. The ambient temperature may in particular be measured by the fifth temperature sensor 45.

During this first step 501, the open diameter of the first expansion device 7 is notably managed such that it decreases as the ambient temperature increases. Thus, whatever the case, refrigerant fluid passes into the first evaporator 11, preventing refrigerant fluid from remaining stagnant within said first evaporator 11. Furthermore, the pressure of the refrigerant fluid passing through the first evaporator 11 is reduced due to the fact that the refrigerant fluid has passed through the first expansion device 7. This limits the risk of damage to the first evaporator 11 as a result of an excessively high pressure of the refrigerant fluid in the first evaporator.

To be specific, the higher the ambient temperature, the more the pressure of the refrigerant fluid at the outlet of the compressor 3 increases in order to compensate for this high ambient temperature. Reducing the open diameter of the first expansion device 7 thus causes a greater pressure drop and therefore the refrigerant fluid passing through the first evaporator 11 is at a lower pressure, allowing better protection of the first evaporator 11. This open diameter of the first expansion device 7 as a function of the ambient temperature may in particular be obtained according to tables of experimental results prepared in the laboratory.

For example, if the ambient temperature is above 25° C., the open diameter of the first expansion device 7 may be of the order of 5% of its maximum open diameter.

If the ambient temperature is less than or equal to 25° C., the open diameter of the first expansion device 7 may be of the order of 20% of its maximum open diameter.

The management method may also include a second step 502 of managing the speed of rotation of the compressor 3 so that the temperature of the third element 300, after heat exchange with the second evaporator 15, reaches and maintains a setpoint value. The temperature of the third element 300 may in particular be measured by the second temperature sensor 42. The temperature setpoint value of the third element 300 may in particular be defined according to various parameters such as, for example, the manufacturer's recommendations or the optimum operating temperature of the third element 300, in particular where it concerns electronic and/or electrical elements such as batteries. This second step 502 may be carried out before, simultaneously with or after the first step 501.

The management method may include, before, simultaneously with or after the first 501 and second 502 steps, a third step 503 of managing the open diameter of the second expansion device 13 as a function of the difference between the overheating of the refrigerant fluid at the outlet of the second evaporator 15 and an overheating setpoint. This overheating setpoint may for example be between 3 and 10° C., preferably between 5 and 8° C.

The management method may comprise, before, simultaneously with or after the first 501, second 502 and third 503 steps, a fourth step 504 of determining the maximum admissible overheating of the refrigerant fluid at the inlet of the compressor 3 (SHR_comp_in_max) for a maximum setpoint temperature of the refrigerant fluid at the outlet of the compressor 3 (TR_comp_out_sp).

For example, the maximum setpoint temperature of the refrigerant fluid at the outlet of the compressor 3 (TR_comp_out_sp) may be 130° C. This temperature is a value defined by the model of compressor 3 and its specifications and/or by the motor vehicle manufacturer's recommendations. This temperature generally corresponds to a temperature beyond which the compressor 3 may be damaged or no longer operate correctly.

The pressure of the refrigerant fluid at the outlet of said compressor 3 (PR_comp_out) is for its part a known value. It may for example be measured by the sixth pressure sensor 46 for detecting the pressure of the refrigerant fluid at the outlet of the compressor 3.

The maximum admissible overheating at the inlet of the compressor 3 (SHR_comp_in_max) may be determined from correspondence tables taking into account the pressure of the refrigerant fluid at the outlet of compressor 3 (PR_comp_out), the maximum admissible temperature of the refrigerant fluid at the outlet of the compressor 3 (TR_comp_out_sp) and the pressure of the refrigerant fluid at the inlet of the compressor 3 (PR_comp_in). The pressure of the refrigerant fluid at the inlet of the compressor 3 (PR_comp_in) is notably obtained by measuring using the fourth pressure sensor 44.

Following the fourth step 504, the management method may include a fifth step 505 of determining the overheating of the refrigerant fluid at the inlet of the compressor 3 (SHR_comp_in). This fourth step 504 is notably carried out according to the following formula:

SHR_comp_in=TR_comp_in−Tsat(PR_comp_in)

where TR_comp_in is the temperature of the refrigerant fluid at the inlet of the compressor 3 and Tsat(PR_comp_in) is the saturation temperature of the refrigerant fluid at the pressure at the inlet of the compressor 3. These two pressure and temperature parameters are obtained in particular by measuring using the third temperature sensor 43 and the fourth pressure sensor 44.

Following the fifth step 505, the management method may include a sixth step 506 of comparing the overheating of the refrigerant fluid at the inlet of the compressor 3 (SHR_comp_in) with the maximum admissible overheating of the refrigerant fluid at inlet of the compressor 3 (SHR_comp_in_max) determined.

If the overheating of the refrigerant fluid at the inlet of the compressor 3 (SHR_comp_in) is greater than the maximum admissible overheating of the refrigerant fluid at the inlet of the compressor 3 (SHR_comp_in_max), the management method comprises a seventh step 507 of lowering the overheating of the refrigerant fluid at the inlet of the compressor 3 (SHR_comp_in) until the overheating of the refrigerant fluid at the inlet of the compressor 3 (SHR_comp_in) is less than or equal to the maximum admissible overheating of the refrigerant fluid at the inlet of the compressor 3 (SHR_comp_in_max).

According to a first embodiment in which the second expansion device 13 is an electronic expansion valve, the seventh step 507 of lowering the overheating of the refrigerant fluid at the inlet of the compressor 3 (SHR_comp_in) is carried out during a first intermediate step 507a of opening the second expansion device 13. This opening of the second expansion device 13 will lead to a reduction in the drop in pressure of the refrigerant fluid when it passes through said second expansion device 13. This reduction in the drop in pressure of the refrigerant fluid will thus lead to a reduction in the overheating of the refrigerant fluid. This also makes it possible to prevent refrigerant fluid from remaining stagnant in the second evaporator 15. As a result, the overheating of the refrigerant fluid at the inlet of the compressor 3 (SHR_comp_in) decreases as does, therefore, the temperature of the refrigerant fluid at the outlet of the compressor 3.

According to a second embodiment, the seventh step 507 of lowering the overheating of the refrigerant fluid at the inlet of the compressor 3 is carried out during a second intermediate step 507a″ of opening the first expansion device 7 so that the refrigerant fluid passes through the first evaporator 11. This second intermediate step 507a′ makes it possible to circulate the refrigerant fluid through the first evaporator 11 and thus to mix a cooler refrigerant fluid coming from said first evaporator 11 with the overheated refrigerant fluid coming from the second evaporator 15. As a result, the overheating of the refrigerant fluid at the inlet of the compressor 3 (SHR_comp_in) decreases as does, therefore, the temperature of the refrigerant fluid at the outlet of the compressor 3.

The opening of the first expansion device 7 is preferably less than a limit value beyond which the high-pressure refrigerant fluid, i.e. the refrigerant fluid between the compressor 3 and the first 7 and second 13 expansion devices, does not experience a drop in pressure, which could adversely affect the performance of the thermal management device 1.

Still according to this second embodiment, if the opening of the first expansion device 7 is not sufficient, the seventh step 507 of lowering the overheating of the refrigerant fluid at the inlet of the compressor 3 may also include a third intermediate step 507b′ in which the speed of rotation of the compressor 3 is reduced. This reduction in the speed of rotation of the compressor 3 causes a reduction in the temperature of the refrigerant fluid at the outlet of the second evaporator 15. As a result, the temperature of the refrigerant fluid at the inlet and outlet of the compressor 3 also decreases.

This second embodiment of the seventh step 507 is particularly suitable when the second expansion device 13 is a thermostatic expansion valve or an orifice tube for which the first embodiment of the seventh step 507 cannot be implemented.

It is thus clear that the management method according to the invention, firstly, allows protection of the first evaporator 11 when the thermal management device 1 operates in a mode of strict cooling of the third element 300. Furthermore, still in this operating mode, the management method may allow protection of the compressor 3 against high refrigerant fluid temperatures which could damage the compressor.

1. A method for managing a thermal management device for a motor vehicle comprising a refrigerant circuit, in which a refrigerant fluid is configured to circulate, said refrigerant circuit comprising:
a main loop comprising, in the direction of circulation of the refrigerant fluid, a compressor, a condenser configured to exchange heat energy with a first element, a first expansion device and a first evaporator configured to exchange heat energy with a second element;
a bypass branch arranged parallel to the first expansion device and the first evaporator, said bypass branch comprising a second expansion device and a second evaporator arranged downstream of the second expansion device and configured to exchange heat energy with a third element,
said thermal management device operating in a mode of strict cooling of the third element in which the condenser transfers heat energy to the first element and only the second evaporator absorbs heat energy from the third element,
said management method comprising: managing the open diameter of the first expansion device as a function of the ambient temperature so that the refrigerant fluid circulates inside the first evaporator, the open diameter of the first expansion device decreasing as the ambient temperature of the first element increases.

2. The management method as claimed in claim 1, wherein:
if the ambient temperature is above 25° C., the open diameter of the first expansion device is of the order of 5% of its maximum open diameter,
if the ambient temperature is less than or equal to 25° C., the open diameter of the first expansion device is of the order of 20% of its maximum open diameter.

3. The management method as claimed in claim 1, further comprising: managing the speed of rotation of the compressor such that the temperature of the third element after heat exchange with the second evaporator reaches and maintains a setpoint value.

4. The management method as claimed in claim 1, further comprising: managing the open diameter of the second expansion device as a function of the difference between the overheating of the refrigerant fluid at the outlet of the second evaporator and an overheating setpoint.

5. The management method as claimed in claim 1, further comprising:
determining the maximum admissible overheating of the refrigerant fluid at the inlet of the compressor for a maximum setpoint temperature of the refrigerant fluid at the outlet of the compressor;
determining the overheating of the refrigerant fluid at the inlet of the compressor;
comparing the overheating of the refrigerant fluid at the inlet of the compressor with the maximum admissible overheating of the refrigerant fluid at the inlet of the compressor determined; and
if the overheating of the refrigerant fluid at the inlet of the compressor is greater than the maximum admissible overheating of the refrigerant fluid at the inlet of the compressor, lowering the overheating of the refrigerant fluid at the inlet of the compressor until the overheating of the refrigerant fluid at the inlet of the compressor is less than or equal to the maximum admissible overheating of the refrigerant fluid at the inlet of the compressor.

6. The management method as claimed in claim 5, wherein the second expansion device is an electronic expansion valve and the step of lowering the overheating of the refrigerant fluid at the inlet of the compressor is carried out by opening said second expansion device.

7. The management method as claimed in claim 5, wherein lowering the overheating of the refrigerant fluid at the inlet of the compressor is carried out by opening the first expansion device such that the refrigerant fluid passes through the first evaporator.

8. The management method as claimed in claim 7, wherein lowering the overheating of the refrigerant fluid at the inlet of the compressor is also carried out by reducing the speed of rotation of the compressor.

9. The management method as claimed claim 1, wherein
the condenser is a heat exchanger arranged jointly on the main loop and on a secondary loop inside which a heat transfer fluid is configured to circulate and the first element is said heat transfer fluid,
the first evaporator is a heat exchanger arranged within a heating, ventilation and air-conditioning device and the second element is an internal air flow intended for the passenger compartment,
the second evaporator is configured to cool electrical and/or electronic elements such as batteries.

10. The management method as claimed in claim 9, wherein the secondary loop comprises:
the first heat exchanger,
a first heat transfer fluid circulation pipe comprising a fifth internal exchanger configured to have the internal air flow passing through it, the first circulation pipe connecting a first connection point arranged downstream of the first heat exchanger and a second connection point arranged upstream of said first heat exchanger,
a second circulation pipe for the first heat transfer fluid comprising a sixth internal exchanger configured to have an external air flow passing through it, the second circulation pipe also connecting the first connection point arranged downstream of the first heat exchanger and the second connection point arranged upstream of said first heat exchanger, and
a pump arranged downstream or upstream of the first heat exchanger, between the first connection point and the second connection point.
